(19) United States
(12) Patent Application Publication
(10) Pub. No.: US 2009/0241999 A1
(43) Pub. Date: Oct. 1, 2009

(54) Modular Stripe Removal System

(76) Inventor: James P. Crocker, Stuart, FL (US)

Correspondence Address: MCHALE & SLAVIN, P.A., 2855 PGA BLVD, PALM BEACH GARDENS, FL, 33410, US

(21) Appl. No.: 12/394,806

(22) Filed: Feb. 27, 2009

Related U.S. Application Data
(60) Provisional application No. 61/032,279, filed on Feb. 28, 2008.

(51) Int. Cl. B08B 3/04

(52) U.S. Cl. 134/111

(57) ABSTRACT

Briefly, disclosed is a stripe removal or cleaning system for removing coatings or markings from hard surfaces, such as roadways, by high pressure liquid. The system employs a liquid reservoir connected to a high pressure fluid pump for directing ultra high pressure water through a blast head to remove the coatings or markings. The blast head is mounted on a vehicle. Water and debris removed from the surfaces are delivered to a vacuum tank where the debris is separated from the water. The vacuum is maintained in the vacuum tank by a high power vacuum pump. The entire removal or cleaning system is mounted on a skid, thus enabling it to be transported to any location and used on vehicles which do not have to be dedicated to stripe removal or surface cleaning.

### RELATED APPLICATIONS

This application claims the benefit under 35 U.S.C. 119(e) of U.S. Provisional Patent Application No. 61/032,279, filed Feb. 28, 2008, entitled “MODULAR STRIPE REMOVAL SYSTEM”, the entirety of which is incorporated herein by reference. This application is also related to U.S. Pat. No. 7,255,116, entitled “STRIPE REMOVAL SYSTEM”; U.S. patent application Ser. No. 11/340,738, filed Jan. 26, 2006, and entitled “TRANSPORTAL HOLDING TANK FOR STRIPE REMOVAL SYSTEM”; U.S. patent application Ser. No. 11/340,104, filed Jan. 26, 2006, entitled “MOBILE MARK REMOVAL SYSTEM”; U.S. patent application Ser. No. 11/368,020, filed Mar. 3, 2006, entitled “ARTICUABLE ARM FOR A MOBILE MARK REMOVAL SYSTEM”; U.S. patent application Ser. No. 11/368,035, filed Mar. 3, 2006, entitled “COMBINED GRINDER AND WATER BLASTER FOR STRIPE REMOVAL”; and U.S. patent application Ser. No. 11/835,642, filed Aug. 8, 2007, entitled “STRIPE REMOVAL SYSTEM”.

### FIELD OF THE INVENTION

This invention relates to the field of high pressure water cleaning devices for highways, airport runways, parking decks, subway stations, ships and other hard surfaces.

### BACKGROUND OF THE INVENTION

The use of paint strips, symbols and indicia on road surfaces is the accepted method to indicate vehicle lanes, crossing lanes, turn lanes, restricted lanes, parking areas and numerous other indicators. Various pavement marking techniques are known, including the use of traffic paint, thermoplastic road marking paint, epoxy paint and preformed tapes. Common pavement surfaces are asphalt and concrete. Most pavement marking systems are intended to be as durable and permanent as possible and resistant to weathering and wear from vehicle traffic. The removal of such striping, symbols and indicia is typically required when the road is to be resurfaced or if the indicia are to be changed. The removal of such strips and indicia is typically performed by use of abrasive wheels, grinding teeth or blasting abrasive particles of material against the strips or indicia to be removed.

However, the use of grinding teeth or abrasive wheels results in an undesirable trench or groove in the road surface.

When polymers such as paint are used for roadway marking, the surface of the pavement is penetrated from about ⅛-⅜ inch, so that surface removal of the marking material is not sufficient to remove the entire marking. As a result, current pavement marking removal machines often employ various forms of cutting devices to remove the marking material on the surface of the roadway and wall as a portion of the underlying layer of roadway also containing the marking material in order to effectively remove the painted lines or indicia.

### DESCRIPTION OF THE PRIOR ART

One type of cutting machine is disclosed in U.S. Pat. No. 5,236,278. It is known and a “Road Pro” grinder and manufactured by Dickson Industries, Inc.

This type of machine employs parallel passive shafts that extend between circular rotating end plates. Hardened steel star wheels are carried on the parallel passive shafts, and these star wheels strike and abrade the pavement surface. While this type of device is effective for removal of markings, they often create excessive heat which may melt thermoplastic materials causing the removal equipment to gum up.

Another approach to pavement marking removal is the use of diamond saw blades arranged to make a dado cut. Still other types of machines use grinders or shot blast as described in U.S. Pat. Nos. 4,753,052; 4,376,358; 3,900,969; 4,336,671; 3,977,128 and 4,377,924. Unfortunately, these devices must remove a portion of the roadway or pavement material to effectively remove the roadway marking, thereby leaving unsightly and potentially dangerous grooves in the roadway or pavement.

NLB Corporation markets a high pressure water jet system from removing paint from pavement under the name “STARJET”. The STARJET system includes a blast head frame mounted on an attachment to the front bumper of a prime-mover truck. Casters support the frame for movement over the pavement and the path of the blast head is controlled by the driver steering the truck. Because of the position of the driver and the cab body of the prime-mover, it is difficult for the operator to see the blast head's position with regard to the stripes on the pavement. Obtaining clear vision requires the driver to lean out of the driver's side window, resulting in fatigue and other non-ergonomically efficient factors. Positioning the blast head to the passenger side of the prime-mover is performed manually with some difficulty and greatly complicating the driver's ability to view the path of the blast head. In addition, due to the length of the extension holding the blast head, the angular off-set and the swivel of the casters, the movement of the wheel of the truck is not directly related to the path of the blast head further complicating the operation.

NLB Corporation also has another system marketed under the mark “STRIPEJET”, that is a self propelled tractor with a blast head on the front of the tractor. The blast head has a shroud and high pressure inlet without a vacuum recovery. A problem associated with the STRIPEJET device relates to the construction of the blast head mounting assembly. The mounting assembly includes a rigid track mounted transversely across the front of the tractor. This construction makes the tractor too long for transport on a truck in a transverse orientation. Transport of the tractor aligned with the longitudinal centerline of the truck requires a substantial amount of bed space, making a one truck stripe removal system impracticable.

BLASTERS Corporation markets a high pressure water device which is mounted on a truck similar to the STARJET device. Yet another model appears to be a self-powered four wheeled tractor, similar to a grass mower, which supports a driver and is connected to the prime-mover by high pressure lines for delivery of high pressure water to a blast head. The blast head is mounted to the front portion of the tractor.

One problem with the prior art systems is that a vehicle is required to be fully dedicated to the stripe removal or cleaning system. The vehicle cannot be used for any other operation or purpose. This is a problem if the company that owns the vehicle does not operate full time as a stripe removal or cleaning company. By mounting the cleaning system on a skid, the system can be placed on a truck or other vehicle and used to perform a removal or cleaning operation. The truck or other vehicle can then be used for other activities subsequent to the cleaning or removal operation. In addition the system mounted on a skid could be delivered to a job site and used without the need for an associated truck or other vehicle. A small tractor could be employed to operate the blast head. A plurality of hoses, one to supply water and one to remove water and debris, would be all that is required to connect the skid mounted system to the tractor.

### SUMMARY OF THE INVENTION

Briefly, disclosed is a stripe removal or cleaning system for removing coatings or markings from hard surfaces, such as roadways, by high pressure liquid. The system employs a liquid reservoir connected to a high pressure fluid pump for directing ultra high pressure water through a blast head to remove the coatings or markings. The blast head is mounted on a vehicle. Water and debris removed from the surfaces are delivered to a vacuum tank where the debris is separated from the water. The vacuum is maintained in the vacuum tank by a high power vacuum pump. The entire removal or cleaning system is mounted on a skid, thus enabling it to be transported to any location and used on vehicles which do not have to be dedicated to stripe removal or surface cleaning.

Accordingly, it is an objective of the instant invention to provide a stripe removal or cleaning system mounted on a skid enabling a compact unit which can be readily transported.

It is a further objective of the instant invention to provide a stripe removal or cleaning system which can be readily mounted on a truck or vehicle so that the vehicle does not have to be dedicated to stripe removal or cleaning of roadways.

It is yet another objective of the instant invention to provide a compact modular cleaning system for fast transportation to job sites.

It is still another objective of the instant invention to provide a compact modular cleaning system which could also be employed to remove paint, coatings and other substances from ships and other vehicles.

It is still yet another object of the instant invention to provide a vacuum tank for removing from the debris of a cleaning operation which includes a filter bag mounted in the vacuum tank and supported by a plurality of straps secured to the top of the bag and hooked onto a plurality of hooks mounted on the interior of the vacuum tank.

It is a still further objective of the invention to provide a vacuum tank for removing water from the debris of a cleaning operation which includes a door or wall which can be readily opened and closed to permit the removal of a filter bag and debris from the vacuum tank.

It is still a further objective of the instant invention to provide a vacuum tank for retaining the debris and materials removed from a roadway and separation and repeated release of filtered water. This permits the debris to be retained in the vacuum tank and the capacity of the vacuum tank is repeatedly available for retention of filtered water used in the removal or cleaning operation. All of the debris is retained until the tank is full and can be dumped. When the debris is dumped, it is dumped as a semi-dried, dewatered material.

Other objects and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1A is a side view of the stripe removal system mounted on a skid;

FIG. 1B is a side view of the stripe removal system with a portion of the skid removed;

FIG. 2 is a side view of a blast head mounted on a tractor;

FIG. 3 is a cross sectional view of the stripe removal system along line 3-3 of FIG. 1;

FIG. 4A is a front view of the vacuum tank;

FIG. 4B is a cross sectional view of the vacuum tank along line 4-4 of FIG. 4A;

FIG. 5A is a top view of the vacuum tank;

FIG. 5B is affront view of the vacuum tank;

FIG. 5C is an end view of the vacuum tank;

FIG. 5D is a perspective view of the vacuum tank;

FIG. 6 is an exploded view of the vacuum tank;

FIG. 7A is a front view of the vacuum tank with the rear door open;

FIG. 7B is a cross sectional view of the vacuum tank along line 7-7 of FIG. 7A;

FIG. 8A is a front view of the vacuum tank with the door open;

FIG. 8B is an end view of the vacuum tank;

FIG. 9A is a perspective view of the vacuum tank;

FIG. 9B is a perspective view of the vacuum tank with the door open and

FIG. 10 is a side view of the system of FIG. 1 mounted on a vehicle.

### DETAILED DESCRIPTION OF THE INVENTION

The stripe removal system 10 of the present invention includes a modular system which is mounted on a skid. This enables the system to be readily deployed to various locations without dedicating the location specifically to the stripe removal system. For example, the system 10 including the skid could be placed on a flatbed truck without permanently converting the truck to a stripe removal system. The system 10 could also be located on the ground and moved to different locations by equipment such as bulldozers, dump trucks, etc. The system 10 could also be placed on a train, airplane or other vehicles and transported to various locations where it would be used to remove markings and other substances from paved roadways, airport runways, parking areas, etc. The system could also be placed in factories, buildings or other structures wherein markings or other materials need to be removed from surfaces. The system could also be employed to remove paint, coatings and other substances from ships and other vehicles.

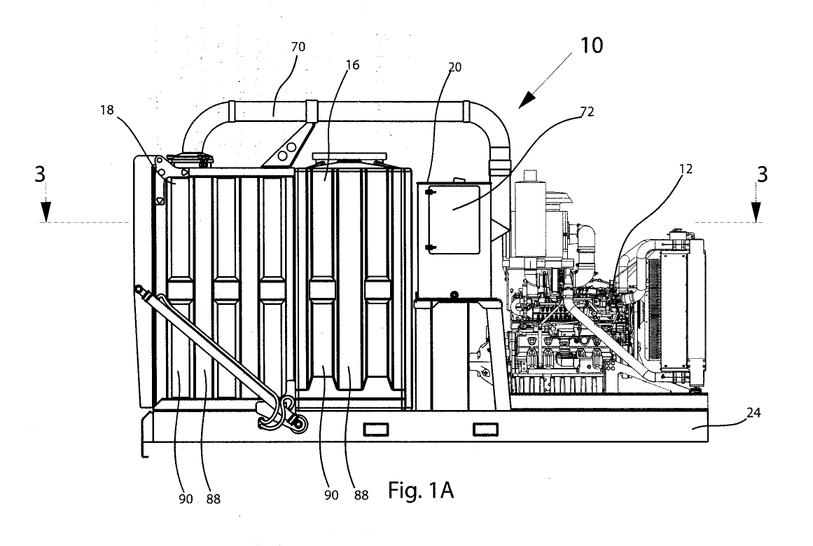

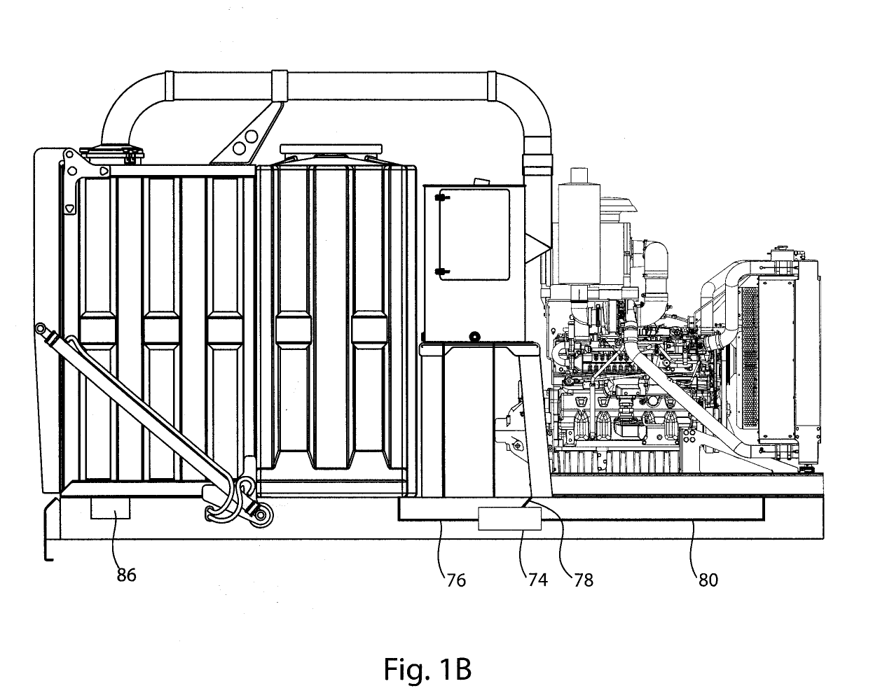

The stripe removal system, as shown in FIGS. 1-3, generally comprises an engine 12, high pressure water or liquid pump 14, a liquid or water reservoir 16, a vacuum tank or sump 18, a high powered vacuum or air pump 20 and a blast head 22. The all of the components of the stripe removal system, except for the blast head, are mounted on a skid 24.

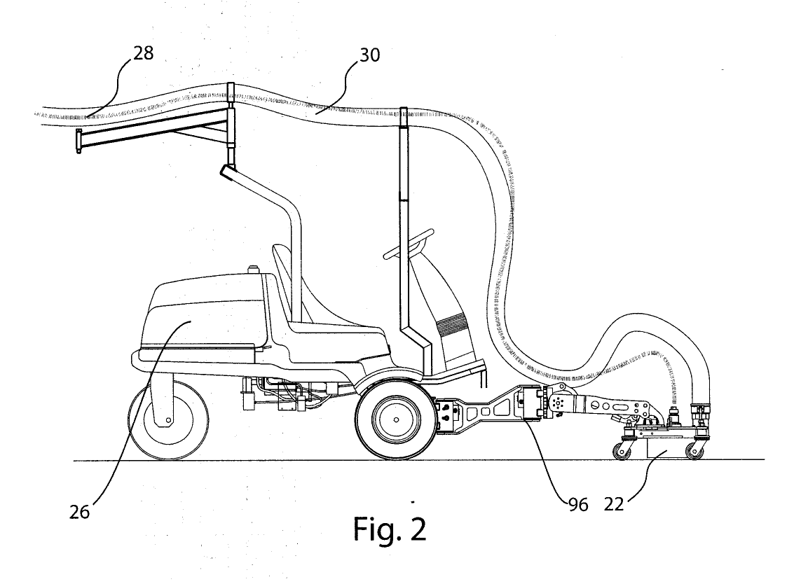

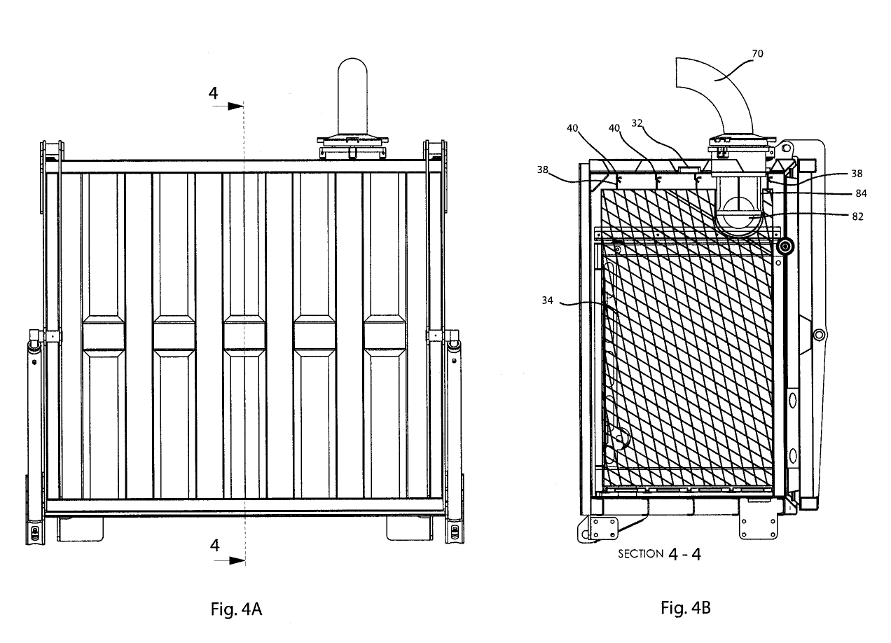

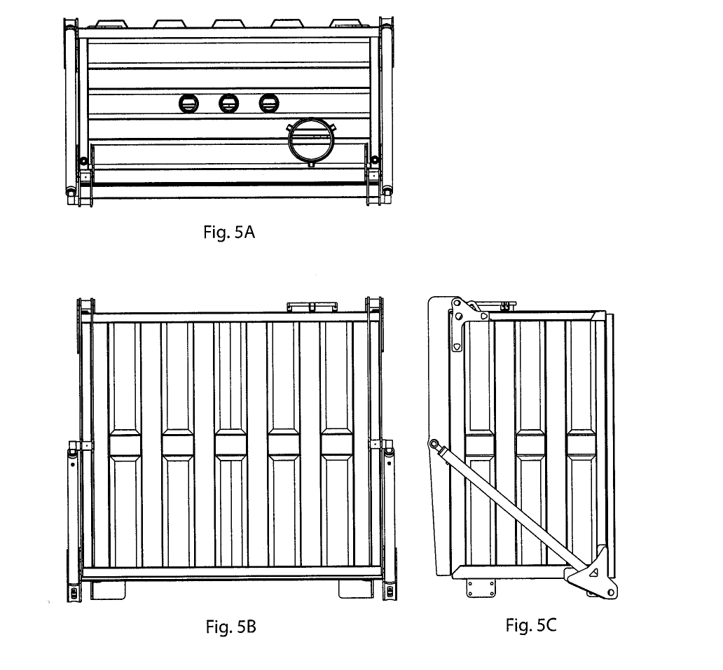

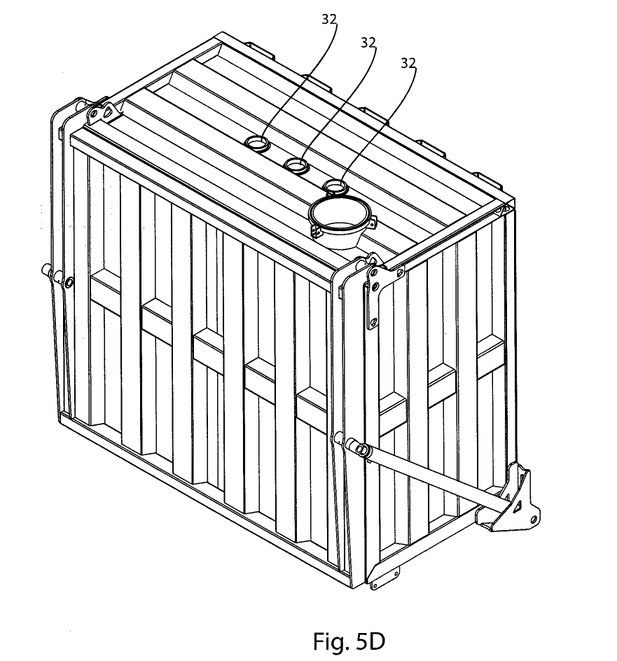

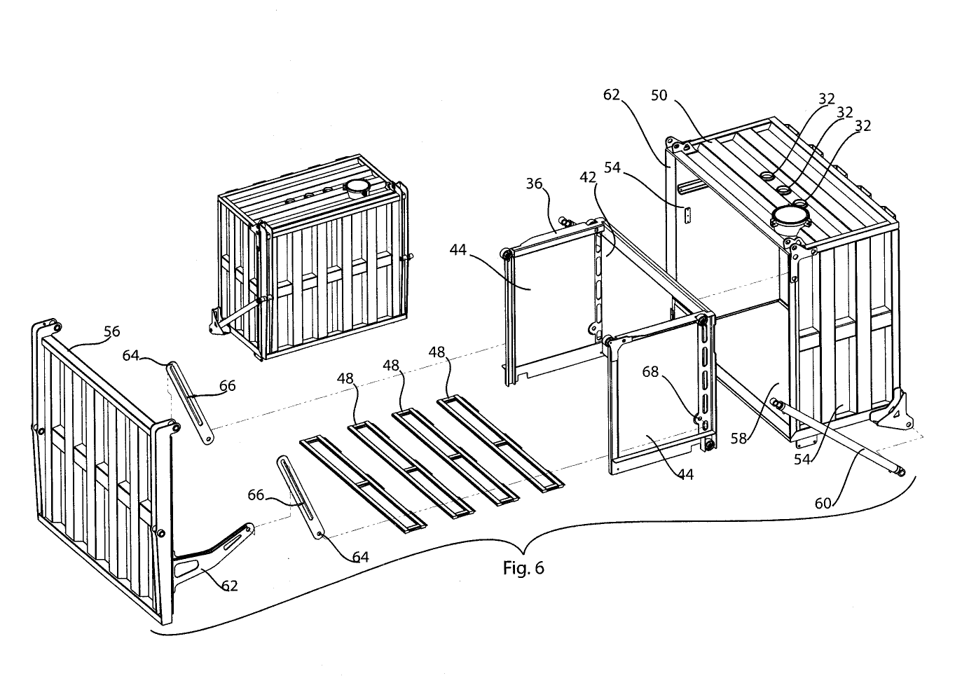

The blast head 22 can be mounted on a small tractor 26, as illustrated in FIG. 2. The blast head can also be mounted on the vehicle onto which the stripe removal system is placed. High pressure water from high pressure water pump 14 is delivered through high pressure fluid lines 28 to the blast head 22. Material, such as paint, thermoplastic road marking paint, epoxy paint, rubber from tires, etc. is removed from a paved surface by the use of high pressure water in the blast head 22. This material and water is removed from the area being cleaned and returned to the vacuum tank 18 via hose 30. The hose 30 is connected to the top of the vacuum tank at one of the inlet ports 32, as illustrated in FIGS. 4B, 5D and 6.

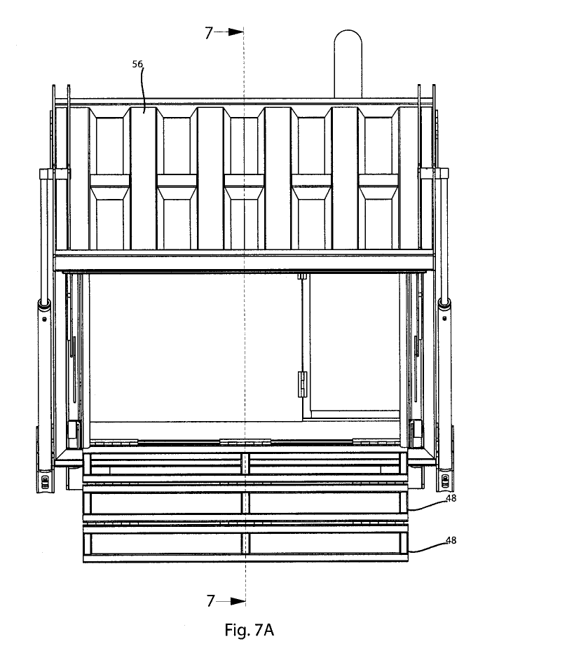

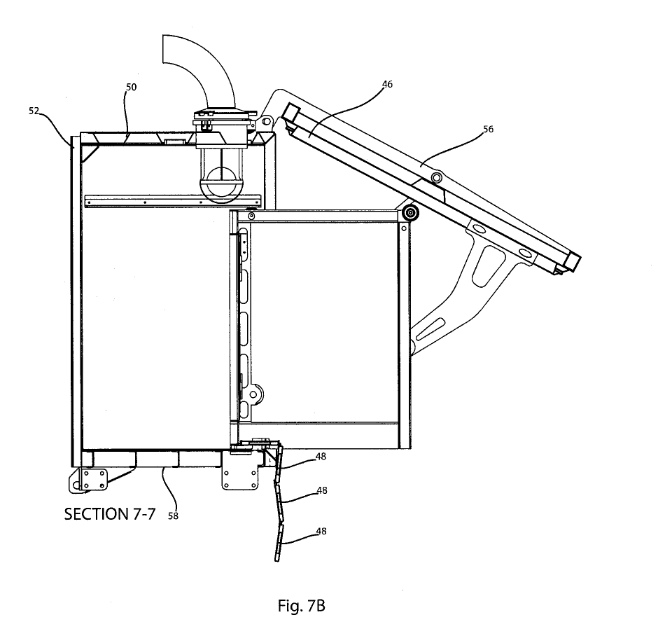

A filter bag 34 is located with in the vacuum tank or sump 18. The filter bag 34 is preferably a parallelepiped with an open top, but could be any other shape. The filter bag preferably has a porosity of between 5-200 microns. However, the porosity may be of any desired size. The filter bag is retained in movable cage 36, FIG. 6. The cage 36 is preferably formed from wire mesh but could be made from any material which is permeable, including perforated plates. The function of the cage is to retain and support the filter bag in its open position enabling it to receive the water and material or debris which has been removed from a surface by the blast head. The cage permits the water to pass through the filter bag and cage and collect in the vacuum tank 18. Cage 36 comprises a rear wall 42, end walls 44, a front wall 46 and a plurality of panels 48 which form the bottom wall. The rear wall, end walls and bottom wall are secured together. The front wall 46 is attached to the movable wall of the vacuum tank 18, FIG. 7B. When the movable wall of the vacuum tank is in its closed position the front wall 46 of the cage engages the end walls of the cage thus enclosing and supporting the filter bag.

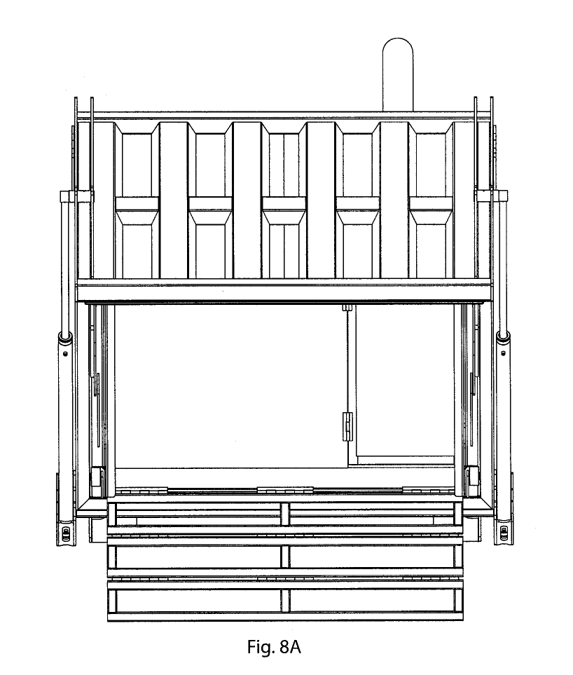

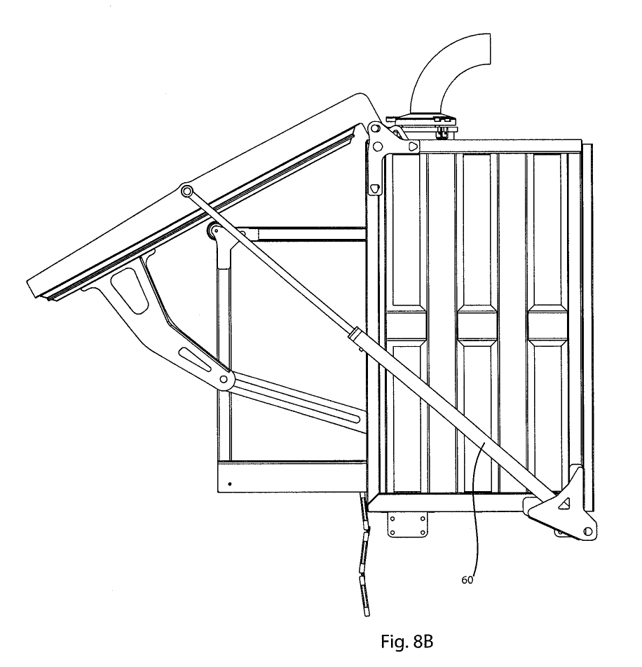

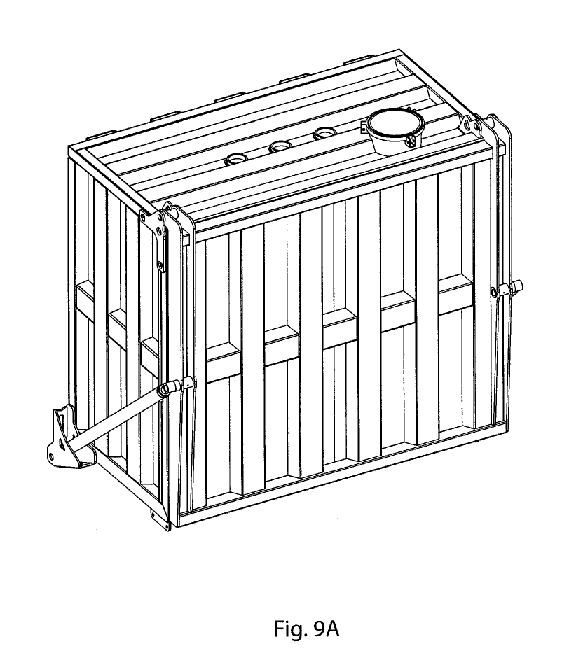

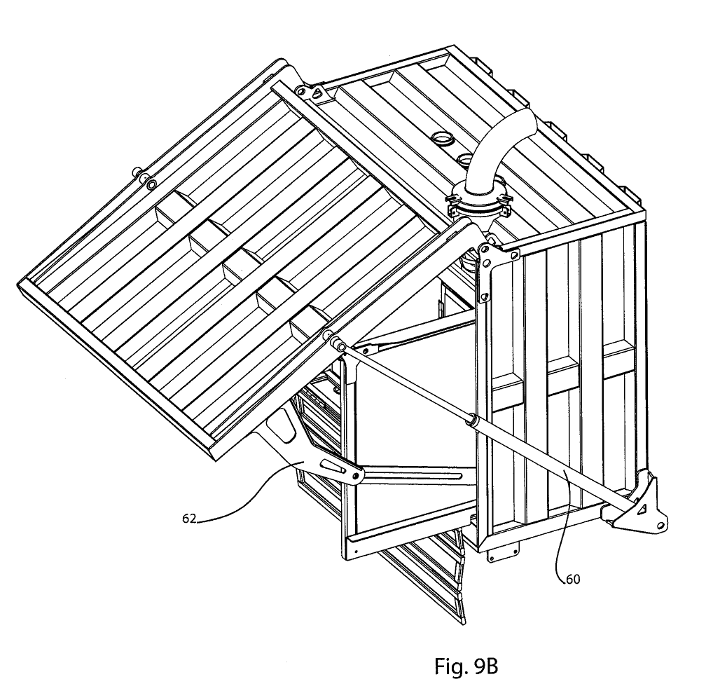

Vacuum tank 18 comprises a top wall 50, a rear wall 52, end walls 54, a movable front wall 56 and a bottom wall 58. Front wall 56 is pivotably secured to top wall 50, as illustrated in FIGS. 7B, 8B and 9B. One end of hydraulic or pneumatic arm 60 is secured to movable wall and the other end of the arm 60 is secured to an end wall 54 of the vacuum tank, FIGS. 7B and 8B. In a preferred embodiment, two hydraulic arms are employed, one on each side of the vacuum tank. The arms 60 maintain the movable wall 56 in its closed position. The perimeter of the opening in the front portion of vacuum tank 18 and the perimeter of the movable wall 56 are both tapered or inclined to permit a water and air tight seal between these members. This tapered fit between the tank and the movable wall 56 also prevents twisting or flexing of the tank 18. A seal 62 can also be placed along the perimeter of the opening of the front portion of the vacuum tank to help maintain a water tight and air tight seal between the movable wall 56 and the remainder of the vacuum tank. The seal is preferably solid but could also be inflatable.

Arms 62 are secured to each end of the movable wall 56. The other end of these arms is secured to bars 64 and moves along slots 66 in the bars 64. One end of the bars 64 are secured to the end walls 44 of the cage 36 at points 68, FIG. 6. This arrangement enables the cage 36 to be withdrawn from the vacuum tank 18 when the movable wall 56 is opened, as seen in FIGS. 7B, 8B and 9B. The front wall 46 of the cage, being secured to the movable wall 56, separates from the remainder of the cage 36 upon movement of wall 56 toward its open position. The bottom of the cage 36 is formed from a plurality of hinged panels 48, as illustrated in FIGS. 6, 7A and 7B. The hinged panels 48 are preferably formed from wire mesh but could be made from any material which is permeable, including perforated plates. The hinged panels 42 support the bottom of the filter bag. The hinged panels 42 are not secured to the end walls 44 of the cage 36, but only to the rear wall 42 of the cage. As illustrated in FIGS. 7a, 7B, 8A and 8B, when the cage 36 is pulled out of the vacuum tank the hinged panels 48 drop away from the cage 36 and permit the filter bag to gradually drop out of the cage. As the filter bag is removed from the vacuum tank the straps or hooks 38 supporting the bag in the tank are torn away from the bag thus permitting the bag and its contents to be completely removed from the vacuum tank. The filter bag 34 can be provided with an opening along its lower portion. This opening is closed by a removable seal. The seal may be employ VELCRO® elements to maintain it in its closed position and permit readily opening of the removable seal. This seal permits the contents of the filter bag to be disposed of in one location while the entire filter bag can be disposed of in a different location.

Air is evacuated from the vacuum tank 18 by high power vacuum pump 20. The sump or vacuum tank 18 is connected to the vacuum pump 20 by hose 70. The hose 70 is connected to an air cleaner 72 prior to it entering the high power vacuum pump so that any debris from the vacuum tank will be removed from the air stream prior to it entering vacuum pump 20. The intake of the high power vacuum pump is capable of handling approximately 1100 CFM (cubic feet per minute). The air discharged from the high power vacuum pump is discharged to the atmosphere. The discharge of the air from the vacuum tank creates a vacuum which draws in the water and debris from the stripe removal or cleaning operation through hose 30 from blast head 22.

Water and debris pass through the opening in the top of filter bag 34. The water passes through the filter bag and cage 36 and is retained in the vacuum tank 18. Filter bag 34 includes loops or straps 38 positioned along the perimeter of the top of the bag, FIG. 4B. The loops or straps are hung onto or secured to hooks 40. The hooks 40 are secured to the interior of the vacuum tank 18. It should also be noted that the hooks 40 could be replaced with other mechanical or mechanical/electrical mean suitable for retaining the filter bag in an open position during use.

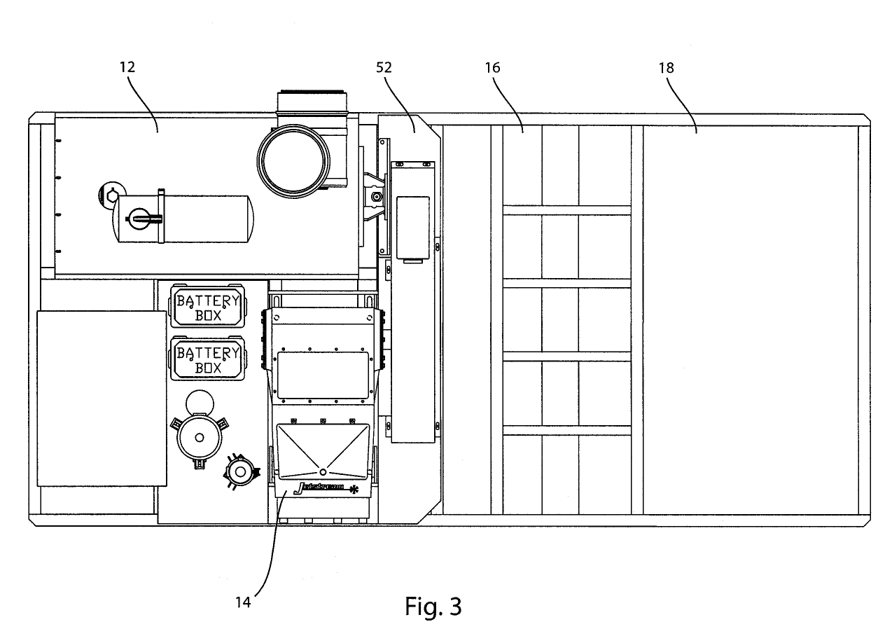

Water reservoir tank 16 contains approximately 600-1500 gallons of liquid. The water is withdrawn from this tank via low pressure pump 74. The pump 74 is connected to the tank 16 by hose 76 to withdraw the water from the reservoir tank. The discharge from pump 74 is sent to high pressure pump 14 via hose 78. The pump 44 is preferably driven off a shaft 80 connected to the output of an engine 12. The pump 74 can also be an electrically, hydraulically or pneumatically operated pump. The high pressure pump 14 has an output of between 2-15 gallons per minute at a pressure of approximately 25,000-60,000 psi. This high pressure water is delivered to the blast head 22 through high pressure fluid lines 28. The high pressure pump 14 is also driven off the engine 12 by a belt and pulley system 52, as illustrated in FIG. 3. Since the water reservoir and vacuum tanks are not interconnected, water can be supplied to the high pressure liquid pump 14 from any source. The other source could be an additional water reservoir tank, a well or a supply such as city water.

Water from the stripe removal or cleaning operation enters the vacuum tank 18 through inlet 32 until it reaches the upper portion of tank 18. A ball 82 is retained in a cage 84 which is secured to the inlet of hose 70. Ball 82 floats in the water and thus when the level of the water in tank 18 raises the ball 82 will close off the inlet of hose 70. This change in pressure of air to the vacuum pump is sensed and the stripe removal operation is stopped. The water is then drained from tank 18 through water outlet 86. After the water has been drained the stripe removal or cleaning operation can begin again. This procedure of filling the vacuum tank with water and debris and the draining the water thereform is repeated until the filter bag is full of debris or solids. The cleaning operation is stopped and the movable front wall 56 of the vacuum tank is opened. The cage and filter bag are removed from the vacuum tank as described above. A new filter bag is hung of hooks 40 and the front wall 56 is closed. Closing of wall 56 moves cage 36 back into vacuum tank 18. The cleaning operation can be resumed again.

The exterior walls of vacuum tank 18 and water reservoir tank 16 are formed with alternating projections 88 and grooves 90, FIG. 1A. The projections 88 of the vacuum tank fit into the grooves 90 of the water reservoir tank 16. This construction enables the tanks to be secured to each other and prevents relative motion of one tank with respect to the other tank. This also enables the tanks to occupy less room on the skid 24.

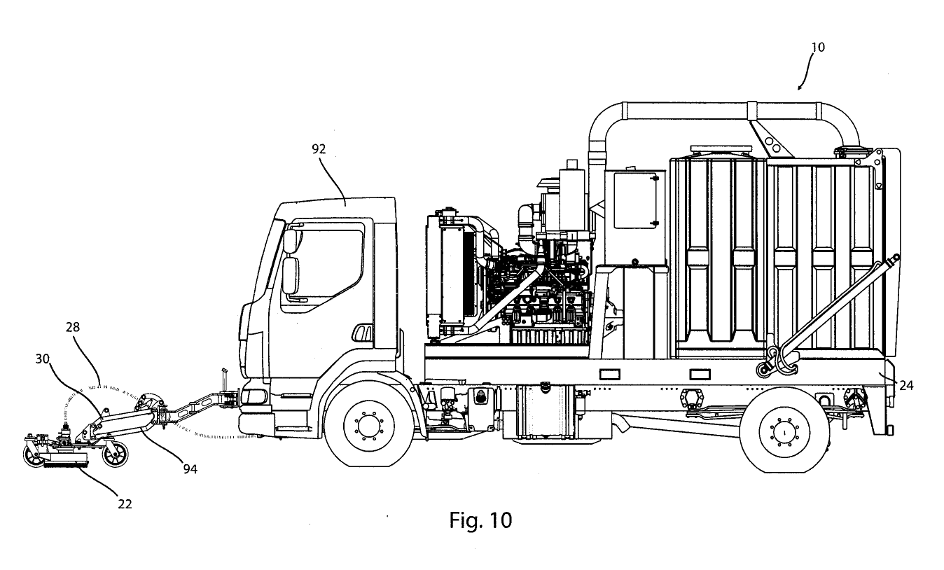

FIG. 10 illustrates the modular stripe removal system 10 mounted on skid 24 placed on a truck 92. The modular system could also be placed on any other type of vehicle including, but not limited to bulldozers, heavy equipment, trains, and aircraft. The tractor 26, illustrated in FIG. 2 could also be carried on the truck or it could be carried on a trailer towed by the truck. In another embodiment, a blast head 22 could be mounted on an arm 94 which is mounted onto the truck, as illustrated in FIG. 10. The arm 94 allows the blast head to be moved in a horizontal plane to remove roadways strips, indicia or other material. It also permits the blast head to be moved vertically and stowed close to or on the truck 92. A similar arm 96 mounts the blast head 22 on the small tractor 26. This arm also moves both horizontally and vertically. In addition a plurality of blast heads could be mounted onto various portions of the truck or other vehicles.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A cleaning system for removing coatings from a hard surface by high pressure liquid comprising:
a liquid reservoir connected to a high pressure pump, said high pressure pump connected to a blast head by a high pressure fluid connection;
a waste removal fluid connection connected at one end to said blast head and at a second end to a sump for collection of liquid and coatings;
said sump having an inlet and an outlet; and
said sump being fluidly connected to said liquid reservoir, whereby liquid is pumped through said high pressure fluid connection from said reservoir to and exits from said blast head onto a hard surface thus removing coatings therefrom, said liquid and coatings entrained by said waste removal fluid connection being transported to said sump, said coatings collected in said sump and liquid waste exiting said sump through said outlet of said sump.

2. The cleaning system of claim 1 wherein a vacuum pump is fluidly connected to said sump.

3. The cleaning system of claim 2 wherein said sump includes a vacuum chamber;
a high power vacuum pump fluidly connected to said vacuum chamber, said vacuum chamber having a substantially non-flexible outside wall defining an interior;
a screen located within said sump and spaced inwardly of said substantially non-flexible outside wall, said screen forming an enclosure;
said vacuum chamber having an inlet fluidly connected to said waste removal fluid connection;
said vacuum chamber having an outlet, said outlet of said vacuum chamber being fluidly connected to said liquid reservoir for re-circulation of said liquid, whereby said liquid and coatings are transported through said waste removal fluid connection by a vacuum generated in said vacuum chamber, said coatings are separated from said liquid and said liquid is returned to said liquid reservoir.

4. The cleaning system of claim 3 wherein said liquid reservoir, said high pressure pump said sump and said vacuum pump are mounted on a skid, said skid and said cleaning system being readily transportable to various different locations.

5. The cleaning system of claim 3 including a fluidly porous flexible bag positioned within said enclosure, said flexible bag having an inlet surrounding said inlet of said vacuum chamber, said liquid passing through said porous flexible bag, said coatings being retained within said flexible porous bag by the size of openings in said flexible porous bag.

6. The cleaning system of claim 1 wherein said blast head includes at least one nozzle; and
a shroud surrounding said at least one nozzle and fluidly connected to said blast head.

7. The cleaning system of claim 6 including said waste removal fluid connection being fluidly connected to said shroud thereby forming a negative pressure chamber.

8. The cleaning system of claim 1 wherein said sump is formed from a plurality of walls, one of said walls being pivotably connected to said sump whereby said one wall can be pivoted to permit access to an interior of said sump.

9. The cleaning system of claim 5 wherein said sump is formed from a plurality of walls, one of said walls being pivotably connected to said sump whereby said one wall can be pivoted to permit access to an interior of said sump, said fluidly porous flexible bag being removable from said sump through an opening created by said one wall pivoting away from said sump.

10. The cleaning system of claim 9 including a plurality of panels positioned on a bottom of said sump, said fluidly porous flexible bag being supported on said panels, said panels being movable relative to said sump whereby said panels assist removal of said fluidly porous flexible bag from said sump.

11. The cleaning system of claim 5 wherein said enclosure being movable relative to said sump whereby said enclosure assists in removal of said fluidly porous flexible bag from said sump.

12. The cleaning system of claim 11 wherein a plurality of panels from a bottom of said enclosure.

13. The cleaning system of claim 12 wherein both said enclosure and said panels are movable relative to said sump whereby said enclosure and said panels assist removal of said fluidly porous flexible bag from said sump.
